(19) United States
(12) Patent Application Publication
(10) Pub. No.: US 2017/0161269 A1
(43) Pub. Date: Jun. 8, 2017

(54) DOCUMENT HANDLING USING TRIPLE IDENTIFIER

(71) Applicant: CA, Inc., Islandia, NY (US)

(72) Inventor: Kristian Klima, Prague (SK)

(21) Appl. No.: 14/959,463

(22) Filed: Dec. 4, 2015

(51) Int. Cl. G06F 17/30; G06F 17/27; G06F 17/28; G06F 3/0482; G06F 17/21

(52) U.S. Cl. CPC G06F 17/30011; G06F 3/0482; G06F 17/218; G06F 17/30554; G06F 17/289; G06F 17/275

(57) ABSTRACT

Embodiment of the disclosure are directed to identifying, for a first document, a subject matter to which the first document pertains; identifying a first unique identifier for the first document associated with the identified subject matter, the first unique identifier comprising a subject matter identifier and a language identifier and a version identifier; and tagging the first document with the first unique identifier. Embodiments are also directed to identifying a second document using at least part of the first unique identifier, the second document comprising a second unique identifier, the second unique identifier comprising a same subject matter identifier as the first unique identifier; and providing an access interface to the second document. Embodiments are also directed to receiving a request through the access interface to the second document; accessing a database associated with the second document; and retrieving the second document from the database associated with the second document.

### BACKGROUND

This disclosure relates in general to the field of electronic document handling, and, more particularly, to the field of electronic document handling (e.g., document augmentation) using a triple identifier.

Multiple documents may exist across versions, languages, use cases, vendors, etc. An end user may wish to augment information provided for one document with information that may exist in other documents of the same subject matter. Such other documents may be accessed using links, such as hypertext markup language links, but such links often require the user to open a new document to view new information about the same subject matter.

### BRIEF SUMMARY

According to aspects of this disclosure, a computer implemented method may include identifying, for a first document, a subject matter to which the first document pertains. A first unique identifier can be identified for the first document associated with the identified subject matter, the first unique identifier including a subject matter identifier and a language identifier and a version identifier. The first document can be tagged with the first unique identifier.

In some embodiments, a second document can be identified using at least part of the first unique identifier, the second document comprising a second unique identifier, the second unique identifier comprising a same subject matter identifier as the first unique identifier. The second document can be provided to a user via a user interface.

### BRIEF DESCRIPTION OF THE DRAWINGS

FIG. 1 is a simplified schematic diagram of an example computing system including one or more host systems and one or more purpose-built devices in accordance with at least one embodiment.

FIG. 2 is a simplified schematic block diagram of an example computing system for tagging a document with a triple identifier in accordance with at least one embodiment.

FIG. 3A is a simplified schematic block diagram of an example computing system for providing additional documents based on a triple identifier in accordance with at least one embodiment.

FIG. 3B is a simplified schematic block diagram of an example computing system for providing additional documents based on a triple identifier in accordance with at least one embodiment.

FIG. 4 is a process flow diagram for tagging a document with a triple identifier in accordance with at least one embodiment.

FIGS. 5A and 5B are process flow diagrams for providing additional documents using a triple identifier in accordance with at least one embodiment.

FIG. 6 is a process flow diagram for aggregating related documents to form a single document in accordance with at least one embodiment.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “ module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

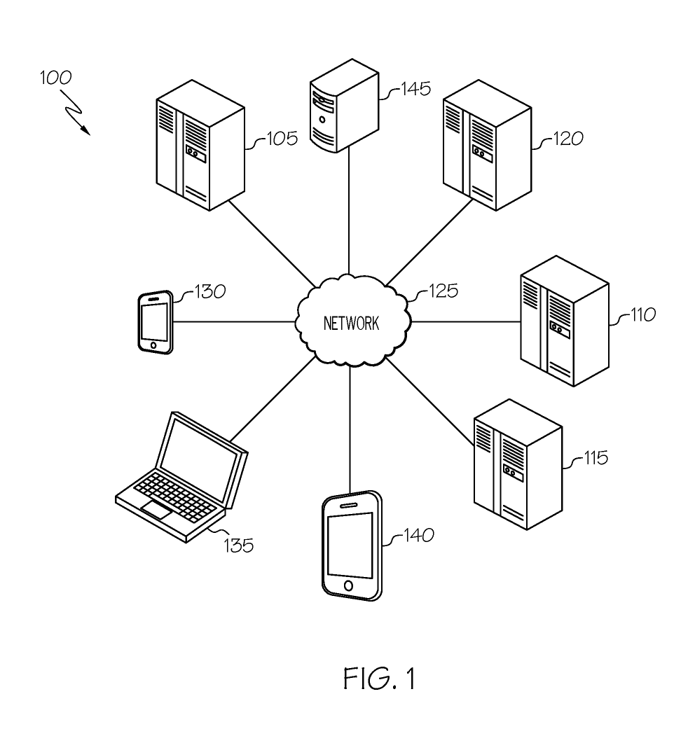

Referring now to FIG. 1, FIG. 1 is a simplified schematic diagram of an example computing system 100 including one or more host systems and one or more purpose-built devices in accordance with at least one embodiment. The computing system include or be in communication with one or more document databases 115, one or more document identifier databases 110, a translation services application 120, a master database 105, and an application server 145.

In general, “servers,” “clients,” “computing devices,” “network elements,” “hosts,” “system-type system entities,” “user devices,” and “systems,” “databases,” “data stores,” “knowledge bases,” “application server,” etc. (e.g., 105, 110, 115, 120, 130, 135, 140, 145, etc.) in example computing environment 100, can include electronic computing devices operable to receive, transmit, process, store, or manage data and information associated with the computing environment 100. As used in this document, the term “computer,” “processor,” “processor device,” or “processing device” is intended to encompass any suitable processing device. For example, elements shown as single devices within the computing environment 100 may be implemented using a plurality of computing devices and processors, such as server pools including multiple server computers. Further, any, all, or some of the computing devices may be adapted to execute any operating system, including Linux, UNIX, Microsoft Windows, Apple OS, Apple iOS, Google Android, Windows Server, etc., as well as virtual machines adapted to virtualize execution of a particular operating system, including customized and proprietary operating systems.

Further, servers, clients, network elements, systems, and computing devices (e.g., 105, 110, 115, 120, 130, 135, 140, 145, etc.) can each include one or more processors, computer-readable memory, and one or more interfaces, among other features and hardware. Servers can include any suitable software component or module, or computing device(s) capable of hosting and/or serving software applications and services, including distributed, enterprise, or cloud-based software applications, data, and services. For instance, in some implementations, servers (e.g., 110, 115, 120, etc.) or other sub-system or component of computing environment 100 can be at least partially (or wholly) cloud-implemented, web-based, or distributed to remotely host, serve, or otherwise manage data, software services and applications interfacing, coordinating with, dependent on, or used by other services and devices in environment 100. In some instances, a server, system, subsystem, or computing device can be implemented as some combination of devices that can be hosted on a common computing system, server, server pool, or cloud computing environment and share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

The system of FIG. 1 can be used to coordinate electronic document handling and tagging. For example, a user operating a device (e.g., 130, 135, 104) can create document for storage in a document database system 115. The user can tag document with a triple identifier that includes a first portion that identifies a subject matter of the document, a second portion that includes a language of the document, and a version number. The triple identifier can be associated with subject matter in a relational database, such as database system 110 that can store triple identifiers and associate each with a subject matter by database, keyword, or other semantic information. A single subject matter identifier can be used to relate documents in various databases using the relational databases. In some embodiments, the document can be tagged with more than one triple identifier.

A document can be displayed to a user over a graphical user interface such as a web browser or document display application. The GUI can display drop down menus organized by database or other information, the drop down menus including a list of documents tagged with the same triple identifier subject matter identifier (but may have different language and version numbers).

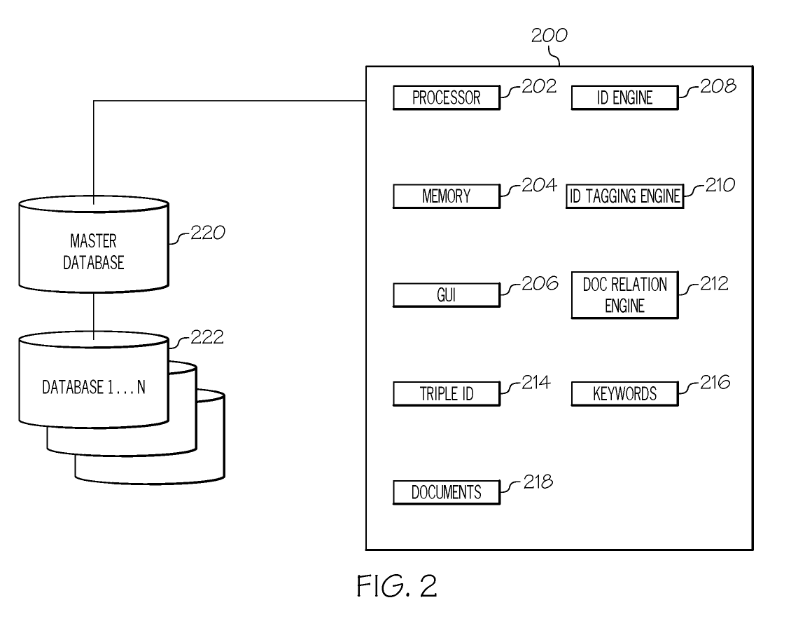

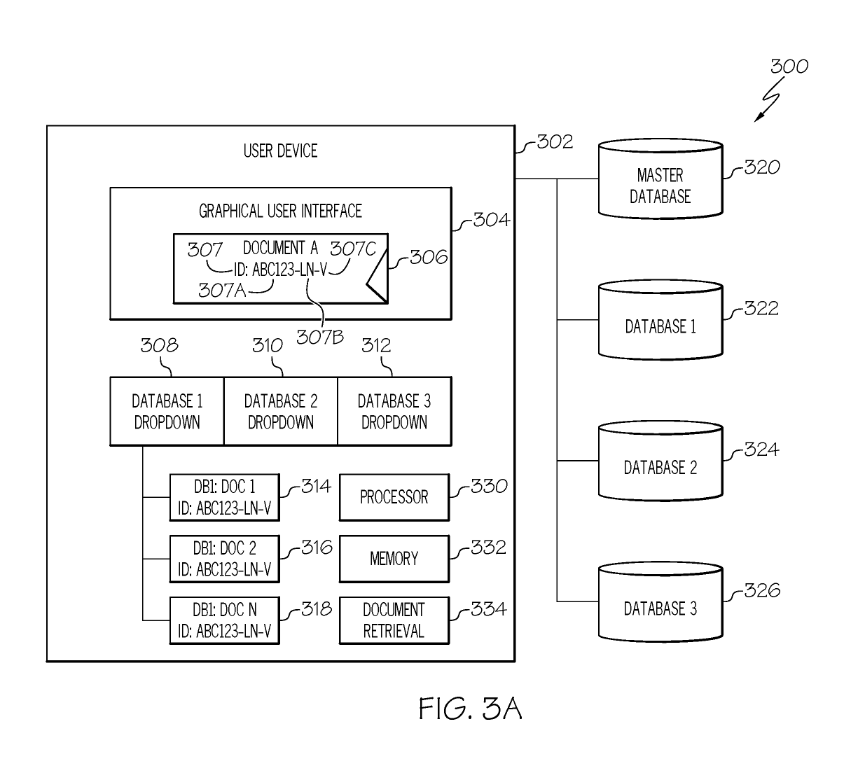

In one example, implementations of a system can be provided, that address at least some of the issues above. Turning to the example of FIG. 2, FIG. 2 is a simplified schematic block diagram of an example computing system 200 for tagging a document with a triple identifier in accordance with at least one embodiment. The computing device 200 can include a processor 202 implemented at least in hardware and a hardware 204. The computing device 200 can also include a graphical user interface (GUI) 206 for displaying electronic documents 218 to a user. The GUI 206 can also provide a way for the user to interact with documents, such as html editors, document editors, remote applications, web browsers, etc. Such interaction can include drafting documents, editing documents, reading/view documents. The user can create documents 218 and tag them with a triple identifier 214. The triple identifier 214 can include a subject matter identifier, a language identifier, and a version number.

Once a document 218 is tagged with an triple identifier 214, the document 218 can be added to a database 222 for storage. The database 222 can be a relational database that stores documents of similar subject matter, similar document type, similar document origin, etc.

When tagging a document 218 with a triple identifier 214, a user can search for existing triple identifier 214 using keywords for the subject matter, a name of a database, or other search terms to accurately identify triple identifier 214 for the new document. In some cases, the user can create a new triple identifier 214, or use a permutation of the existing triple identifier's components. For example, a triple identifier can include ABC123_EN_1.0, and the user can create a new triple identifier that is a permutation of ABC123_EN_1.0, which could be ABC123_EN_2.0.

An ID engine 208 can be used in some cases to generate a triple identifier 214 either based on a search for existing identifiers or based on generating a new identifier that is not already in use. The ID tagging engine 210 can link the triple identifier 214 with the appropriate database(s). In some embodiments, documents generated based on existing documents that have triple identifier tags can be automatically tagged with the same triple identifier or a permutation of the triple identifier components. An example may be an electronic document that includes a discussion thread concerning an existing document.

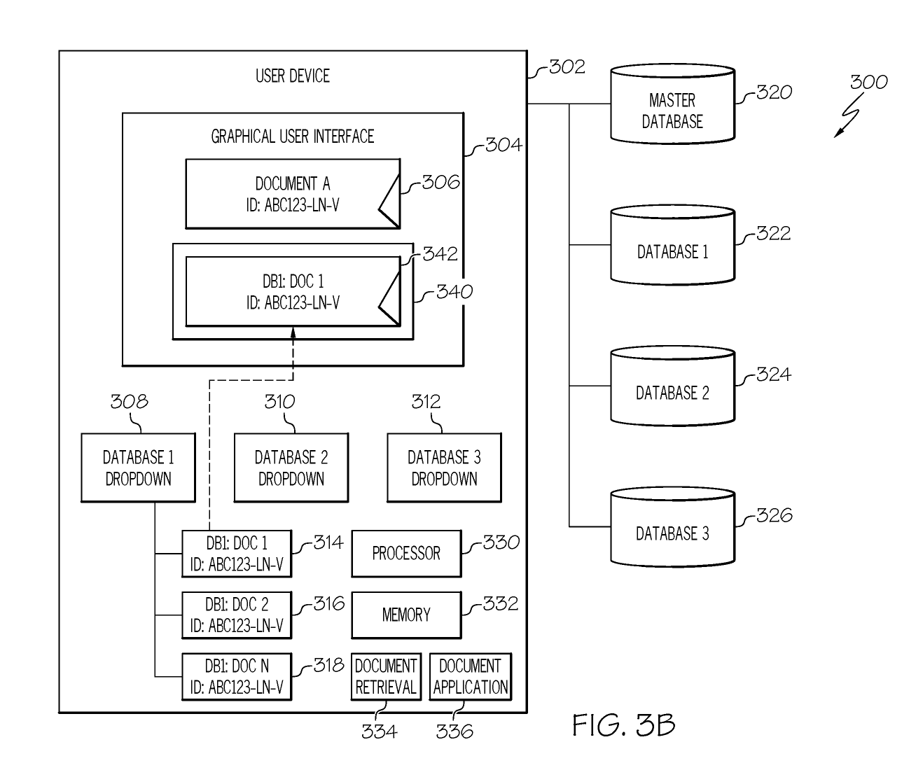

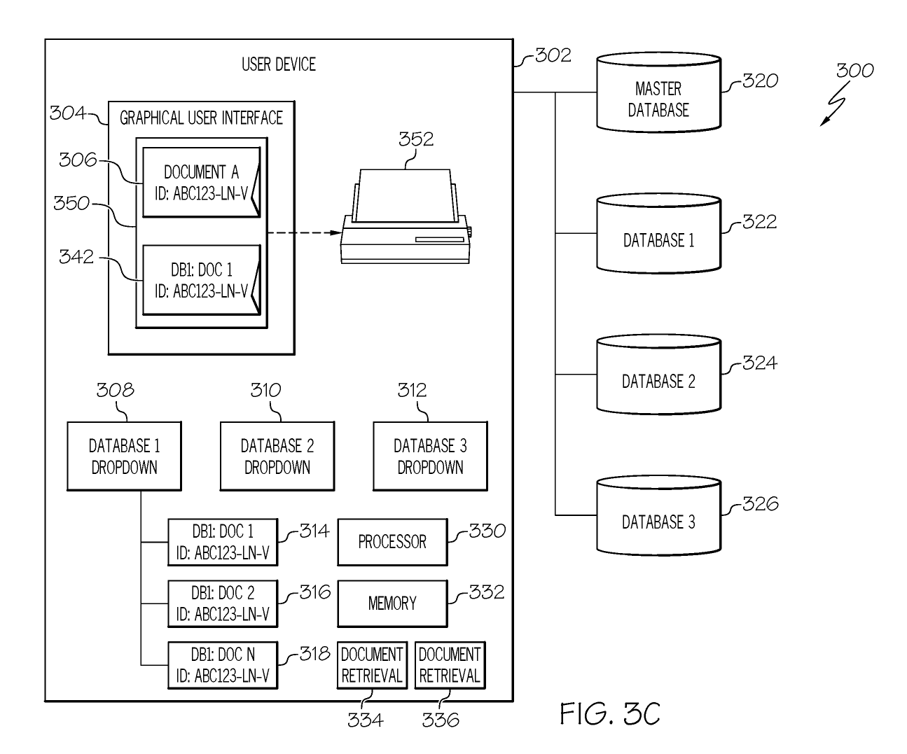

The GUI 206 provides a user interface to a user for viewing electronic documents 218. The document relation engine 212 can be used to identify documents and document databases that have the same triple identifier 214 as the displayed document (or a permutation of the same triple identifier, but with sufficient document identification information to uniquely identify the document). More details on the display of documents is shown in FIGS. 3A-3B:

FIG. 3A is a simplified schematic block diagram of an example computing system 300 for providing additional documents based on a triple identifier in accordance with at least one embodiment. The computing system 300 can include similar features as computing system 200, such as the GUI 206, which is referred to as GUI 304. The computing system 300 can include a user device 302. User device can include a processor 330 and memory 332.

The user device 302 can include a GUI 304 that can be used to display a document, such as Document A 306. Document A 306 can include a triple identifier ABC123-LN-V 307. The triple identifier 307 can include first portion 307a that represents a subject matter or topic of the document. The first portion 307 can uniquely identify a subject matter for the document. In some embodiments, the first portion 307 can be structured to include a subject matter identifier and a unique document identifier. The first portion 307 of the triple identifier can be used to relate documents (in the same or different database) in a relational database. In some embodiments a master database 320 can be used to aggregate information relationally from across databases, such as database 1 322, database 2 324, database 3 326, etc.

The triple identifier 307 can include a second portion 307b that may include a language identifier. The language identifier can provide an indication of the language of the document 306.

The triple identifier 307 can include a third portion 307c that may include a version identifier (number, letter, etc.). The version identifier can track the version of the document 306.

The GUI 304 can also include one or more drop down menus, each drop down menu providing an indication of a database name that includes documents that share at least a portion of the same first portion of the triple identifier as the currently displayed document A 306. For example, database 1 dropdown 308, database 2 dropdown 310, and database dropdown 312 can be displayed for document A 306.

A document retrieval module 334 can identify the triple identifier 307 from the displayed document and identify one or more related documents from a master database 320. When a listed related document is selected for viewing, the document retrieval module 334 can retrieve the document from one or more databases 1-3 (322-326).

Database 1 dropdown 308 can include a list of documents contained therein that share at least a portion of the first portion of the triple identifier 307. In the example shown in FIG. 3A, database 1 dropdown includes a list containing names of three related documents: Doc 1 314, Doc 2 316, and Doc 3 318. Each of doc 1 through doc 3 include a triple identifier that shares at least a portion of the first portion of the triple identifier 307 of document A 306.

FIG. 3B is a simplified schematic block diagram of an example computing system 300 for providing additional documents based on a triple identifier in accordance with at least one embodiment. In FIG. 3B, the user can select a document from the drop down menu for display within a portion of the GUI 304. For example, if a user selects Doc 1 314 from the database 1 dropdown menu for display, a document retrieval module 334 can retrieve the Doc 1 342 from database 1 322.

The GUI 304 can display the document 314 to the user with the document A 306. In some embodiments, the GUI 304 can use a document application 336 to identify a type of document for Doc 1 342 and to run an application 340 compatible with Doc 1 (e.g., if Doc 1 is a pdf, the GUI 304 can open a PDF viewer to display the document). The document application 336 can open an embedded application 342 within the GUI 304 while still displaying Document A 306 in GUI 304.

FIG. 3C is a simplified schematic block diagram of an example computing system 300 for providing additional documents based on a triple identifier in accordance with at least one embodiment. In FIG. 3C, the Document A 306 and related Doc 1 342 can be aggregated into a single document 350. The single document 350 can be stored in a memory as a new document with the triple identifier 314, printed by a peripheral device 352, or printed to file, such as printing to a PDF or other type of document.

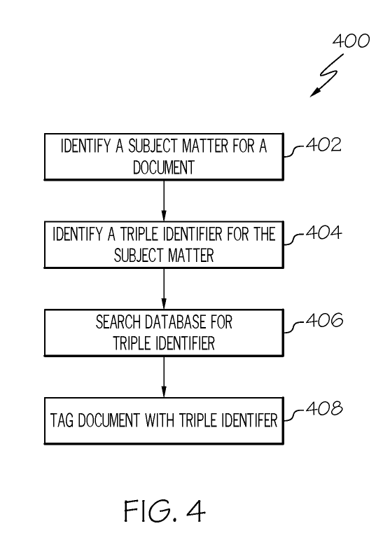

FIG. 4 is a process flow diagram 400 for tagging a document with a triple identifier. Documents can be tagged with triple identifiers by a creator of a document or automatically in some embodiments. A subject matter for the document can be identified (402). The identification of the subject matter of the document can be performed by the creator of the document; in some embodiments, the subject matter of the document can be identified by an existing triple identifier of a related document (e.g., for a discussion thread generated based on an existing document, the subject matter of the discussion thread can be identified by the triple identifier of the progenitor document). In some embodiments, a user can perform a search for topics or subject matter using keywords or database names to identify existing subject matter names and categorizations to avoid duplication.

A triple identifier can be identified for the identified subject matter (404). The triple identifier for the subject matter can include a subject matter identifier, a language identifier, and a version identifier. The language identifier can be selected based on the language of the document from a list of approved language identifiers (e.g., EN for English, FR for French, etc.). The version identifier can be an alpha-numeric identifier.

The subject matter identifier can be identified by the creator of the document. In some embodiments the subject matter identifier can be selected arbitrarily. In some embodiments, the subject matter identifier can identified based on the subject matter of the document. For example, a creator of a document can search for established subject matters or topics or databases for subject matter to determine whether corresponding subject matter identifiers have been established (406).

In some embodiments, the triple identifier can include a subject matter identifier that includes subparts. A first subpart can include an identifier for a subject matter, and a second subpart can include a unique identifier for the document. Subsequent documents can have a triple identifier that includes the same first and second subparts as the triple identifier of the progenitor document.

The document can then be tagged with a triple identifier (408). In some embodiments, the creator of the document can tag the document; in some embodiments, a document is tagged automatically.

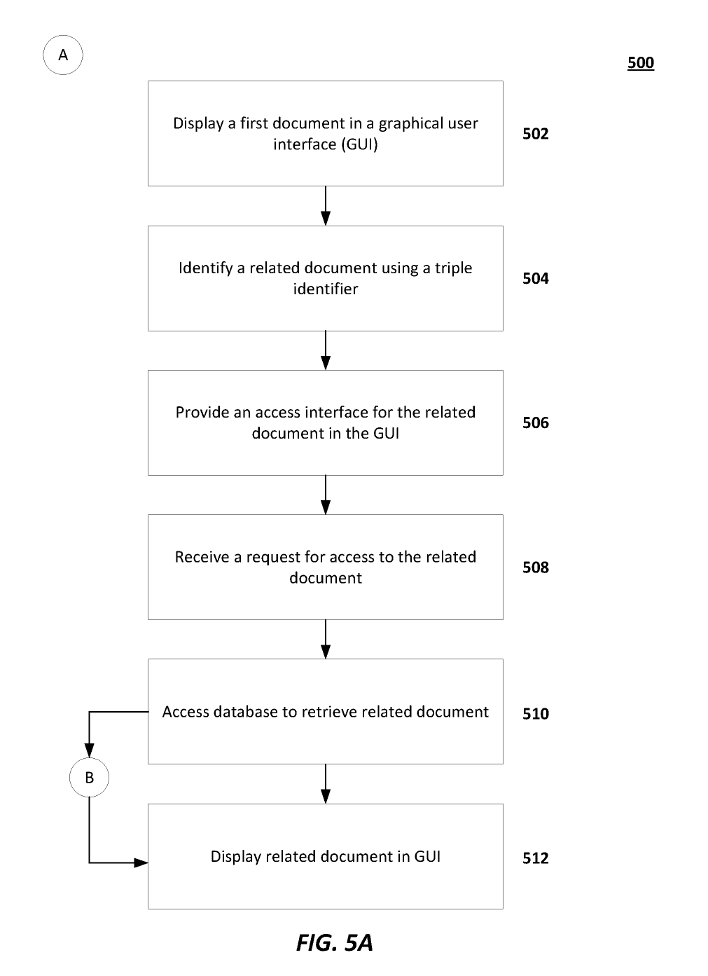

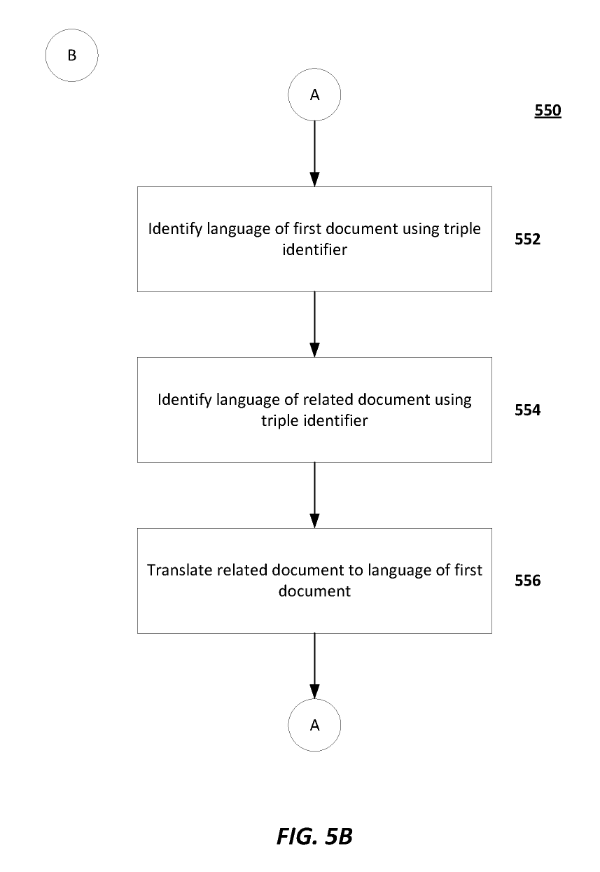

FIG. 5 is a process flow diagram 500 for providing additional documents using a triple identifier. FIG. 5 is split between 5A and 5B for clarity purposes.

As shown in FIG. 5A, a first document can be displayed in a graphical user interface (GUI) (502). One or more related documents can be identified for the first document based on a triple identifier associated with the first document (504). An interface, such as a drop down menu, can be provided in the GUI that lists the one or more related documents (506). A request to access a related document can be received (508). A database that stores the related document can be accessed to retrieve the related document (510). The related document can be displayed in the GUI with the first document (512).

FIG. 5B shows an optionally process flow 550. After a related document is accessed from the database, the related document can be translated into a language of the first document using a translation service, such as a cloud based translation service 120 shown in FIG. 1. A language for the first document can be identified using the language identifier from the triple identifier of the first document (552). A language of the related document can be identified using the related document's triple identifier (554). The related document can be translated into the language of the first document prior to being displayed in the GUI (556).

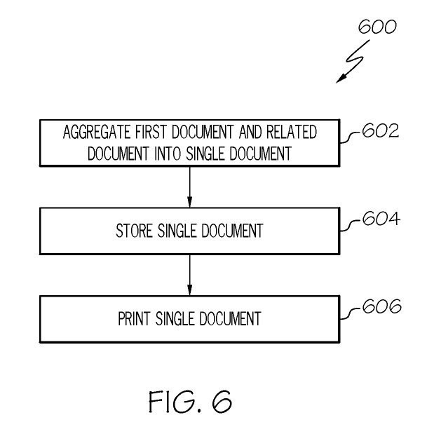

FIG. 6 is a process flow diagram 600 for aggregating related documents to form a single document in accordance with at least one embodiment of the present disclosure. A first document and a related document can be combined to form a single document (602). The two documents can be converted into a common format prior to aggregating into a single document. The single document can be stored (604). In some embodiments, the user can print the single document (606).

The flowcharts and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

1. A computer implemented method comprising:
identifying, for a first document, a subject matter to which the first document pertains;
identifying a first unique identifier for the first document associated with the identified subject matter, the first unique identifier comprising a subject matter identifier and a language identifier and a version identifier; and
tagging the first document with the first unique identifier.

2. The computer implemented method of claim 1, further comprising:
identifying a second document using at least part of the first unique identifier, the second document comprising a second unique identifier, the second unique identifier comprising a same subject matter identifier as the first unique identifier; and
providing an access interface to the second document.

3. The computer implemented method of claim 2, wherein the access interface comprises a drop down menu.

4. The computer implemented method of claim 2, wherein the access interface identifies a database in which the second document is stored.

5. The computer implemented method of claim 2, further comprising:
receiving a request through the access interface to the second document;
accessing a database associated with the second document; and
retrieving the second document from the database associated with the second document.

6. The computer implemented method of claim 5, further comprising displaying the second document on a same graphical user interface as the first document.

7. The computer implemented method of claim 5, further comprising:
identifying a first language of the first document based on the language identifier in the first unique identifier;
identifying a second language of the second document based on a language identifier of the second unique identifier;
determining that the first language and the second language are different;
translating the second language into the first language; and
displaying the second document in the first language.

8. The computer implemented method of claim 1, wherein identifying the subject matter for the first document comprises identifying a keyword from the first document; and
wherein identifying the unique identifier based on the subject matter comprises:
searching a database of unique identifiers using the keyword; and
identifying the unique identifier from the database of unique identifiers.

9. The computer implemented method of claim 1, wherein tagging the first document with the unique identifier comprises adding the unique identifier to metadata of the first document.

10. The computer implemented method of claim 1, wherein identifying a unique identifier for the first document further comprises generating a new subject matter identifier for the subject matter to which the first document pertains.

11. The computer implemented method of claim 1, wherein tagging the first document with the unique identifier comprises adding unique identifier to a uniform record locator (URL) or hypertext markup language (HTML) address.

12. A system comprising:
a memory for storing instructions; and
a processor implemented at least in hardware operable to:
identify, for a first document, a subject matter to which the first document pertains;
identify a first unique identifier for the first document associated with the identified subject matter, the first unique identifier comprising a subject matter identifier and a language identifier and a version identifier; and
tag the first document with the first unique identifier.

13. The system of claim 12, wherein the processor is further operable to:
identify a second document using at least part of the first unique identifier, the second document comprising a second unique identifier, the second unique identifier comprising a same subject matter identifier as the first unique identifier; and
provide an access interface to the second document.

14. The system of claim 12, wherein the processor is further operable to:
receive a request through the access interface to the second document;
access a database associated with the second document; and
retrieve the second document from the database associated with the second document.

15. The system of claim 14, wherein the processor is further operable to:
identify a first language of the first document based on the language identifier in the first unique identifier;
identify a second language of the second document based on a language identifier of the second unique identifier;
determine that the first language and the second language are different;
translate the second language into the first language; and
display the second document in the first language.

16. The system of claim 14, wherein the processor is further operable to display the second document on a same graphical user interface as the first document.

17. The system of claim 12, wherein tagging the first document with the unique identifier comprises adding the unique identifier to metadata of the first document.

18. The system of claim 12, wherein tagging the first document with the unique identifier comprises adding unique identifier to a uniform record locator (URL) or hypertext markup language (HTML) address.

19. The system of claim 12, wherein identifying the subject matter for the first document comprises identifying a keyword from the first document; and
wherein identifying the unique identifier based on the subject matter comprises:
searching a database of unique identifiers using the keyword; and
identifying the unique identifier from the database of unique identifiers.

20. A computer program product comprising a computer readable storage medium comprising computer readable program code embodied therewith, the computer readable program code comprising:
computer readable program code configured to identify a first document for displaying over a graphical user interface;
computer readable program code configured to identify a document identifier for the first document;
computer readable program code configured to identify a second document related to the first document using the document identifier; and
computer readable program code configured to provide an access interface to the second document over the graphical user interface.
